(19) United States
(12) Patent Application Publication
(10) Pub. No.: US 2002/0099654 A1
(43) Pub. Date: Jul. 25, 2002

(54) Internet web site for providing portion of purchase price to donees and/or back to purchasers

(76) Inventor: Sunitha Nair, North Brunswick, NJ (US)

Correspondence Address: Mr. Walter J. Tencza Jr., Suite 3, 10 Station Place, Metuchen, NJ, 08840, US

(21) Appl. No.: 09/767,326

(22) Filed: Jan. 23, 2001

(51) Int. Cl. G06F 17/60

(52) U.S. Cl. 705/40

(57) ABSTRACT

A method is provided comprising the steps of providing a Internet web site which allows a purchaser to make purchases through the Internet web site and to select donees to give a portion of the purchase price to. In one embodiment of the present invention the donees and the purchaser are located in a single township. The present invention can be thought of as creating an Internet community and as being a portal for serving the residents in a community. An Internet web site in accordance with the present invention may include information about a particular community or township and about the surrounding communities or townships, information about large and small businesses in the community, job listings, shopping and sale information, listings and activities of charitable organizations, government offices and their services and the like. Anyone using a web site in accordance with the present invention may help their township, their schools and/or charitable organizations of their choice, particularly organizations within the community or township. Alternatively or additionally a portion of the money a user spends through the web site may be provided back to the user as stock for ownership in the company that owns the web site. The Internet web site may provide a list of potential donees and the purchaser may select donees from the list of potential donees. The purchaser may select the portions of purchase amounts of money to be provided to particular donees. The portions may be percentages. The portions may be displayed on a computer display. As a community portal, residents will have the option to post items for sale, exchange etc. using the portal.

### FIELD OF THE INVENTION

This invention relates to methods and apparatus for encouraging people to purchase products and to provide money to charitable and/or local organizations.

### BACKGROUND OF THE INVENTION

Various companies during promotions dedicate part of the purchase price of an item, such as a product or services, to a particular charitable organization. For example, VISA (trademarked) has had promotions where they donated portions of amounts of money from purchases using a VISA card to the United States Olympic team. These promotional charitable contribution schemes are typically short lived. In addition, the purchaser of a item typically has no role in deciding where, or to whom, the portions of money are sent.

### SUMMARY OF THE INVENTION

A method is provided comprising the steps of providing a Internet web site which allows a purchaser to make purchases through the Internet web site and to select donees (which may be for example charities) to give a portion of the purchase price to. Charities, in the present application, include not for profit organizations like schools, or any organization supporting a public cause. In one embodiment of the present invention the donees and the purchaser are located in a single township. In this manner the present invention can be thought of as creating an Internet community and as being a portal for serving the residents in a community but in at least one embodiment at the same time providing access to the entire Internet community if the user needs it. An Internet web site in accordance with the present invention may include information about a particular community or township and about the surrounding communities or townships, information about large and small businesses in the community, job listings, shopping and sale information, listings and activities of charitable organizations, government offices and their services and the like. Anyone using a web site in accordance with the present invention may help their township, their schools and/or charitable organizations of their choice, particularly organizations within the community or township. Alternatively or additionally a portion of the money a user spends through the web site may be provided back to the user as stock for ownership in the company that owns the web site.

The Internet web site may provide a list of potential donees and the purchaser may select donees from the list of potential donees and the purchaser may add a donee if a particular donee is not listed. The purchaser may select the portions of purchase amounts of money to be provided to particular donees. The portions may be percentages or absolute amounts. The portions may be displayed on a computer display.

As a community portal, residents will have the option to post items for sale, exchange etc. using the portal. A option can be provided to choose an address display to help people make quick purchase/exchange decisions since they in some embodiments may know who is offering the item and where the item is being offered for sale and whether items may be picked up rather than mailing etc. In addition, this also builds trust among the residents in the communities.

### BRIEF DESCRIPTION OF THE DRAWINGS

FIG. 1 shows a block diagram of an apparatus for use with an embodiment of the present invention, wherein the apparatus includes a user display;

FIG. 2 shows a home web page which can be displayed on the user display of FIG. 1;

FIGS. 3A and 3B show versions of a main page which can be displayed on the user display of FIG. 1;

FIG. 4 shows a township selection for browsing page which can be displayed on the user display of FIG. 1;

FIG. 5 shows a customer entry web page which can be displayed on the user display of FIG. 1;

FIG. 6 shows a new customer registration information web page which can be displayed on the user display of FIG. 1;

FIG. 7 shows a new customer registration information/List of charities web page which can be displayed on the user display of FIG. 1;

FIG. 8 shows a vendor/business entry web page which can be displayed on the user display of FIG. 1;

FIG. 9 shows a vendors/new businesses registration information page which can be displayed on the user display of FIG. 1;

FIG. 10 shows a charitable/not-for-profit organization entry web page which can be displayed on the user display of FIG. 1;

FIG. 11 shows a new charitable organization registration web page which can be displayed on the display of FIG. 1;

FIG. 12 shows an order information web page which can be displayed on the user display of FIG. 1;

FIG. 13A shows a begin checkout web page which can be displayed on the user display of FIG. 1;

FIG. 13B shows a new customer check out web page which can be displayed on the user display of FIG. 1;

FIG. 13C shows a registered customer check out web page which can be displayed on the user display of FIG. 1;

FIG. 14A shows a first version of a registered customer account information web page which can be displayed on the user display of FIG. 1;

FIG. 14B shows a second version of a registered customer account information web page which can be displayed on the user display of FIG. 1;

FIG. 15 shows a charitable organization account information web page which can be displayed on the user display of FIG. 1;

FIG. 16 shows a registered vendor account information web page which can be displayed on the user display of FIG. 1;

FIG. 17 shows a local shops web page which can be displayed on the user display of FIG.

FIG. 18 shows a web page for a specific local shop which can be displayed on the user display of FIG. 1; and

FIG. 19 shows a web page for garage sales which can be displayed on the user display of FIG. 1.

### DETAILED DESCRIPTION OF THE DRAWINGS

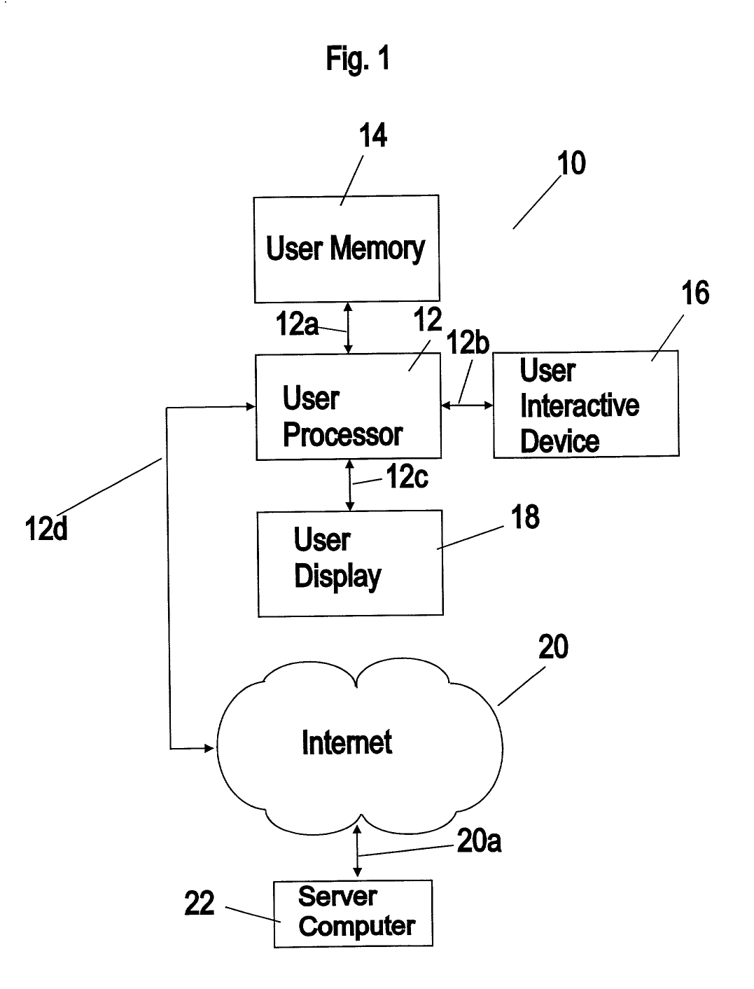

FIG. 1 shows a block diagram of an apparatus 10 for use with an embodiment of the present invention. The apparatus 10 includes a user processor 12, a user memory 14, a user interactive device 16, a user display 18, the Internet 20, and a server computer 22. The server computer 22 may include computer memory and a computer processor. The processor 12 may be a computer processor; the memory 14 may be computer memory such as RAM (random access memory); the interactive device 16 may include a computer keyboard and a computer mouse; and the display 18 may be a computer cathode ray tube display or any other type of computer display. The display 18 may be a touch screen and thus may also function as an interactive device or may be part of the interactive device 16.

The processor 12 is electrically connected (which may include connections in a hardwired manner or in a wireless manner) to memory 14 by bus 12a, interactive device 16 by bus 12b and display 18 by bus 12c. The processor 12 is electrically connected (which again may include connections in a hardwired manner or in a wireless manner) to the server computer 22 by telecommunications channel 12d, the Internet 20, and telecommunications channel 20a. The processor 12 may be a computer or part of a computer, such as a personal computer, which is connected to the Internet 20 via telecommunications channel 12d, which may be any hardwired or wireless connection or any combination or hardwiring or wireless connection. The combination of the processor 12, user memory 14, user interactive device 16, and user display 18 may be a computer, such as a personal computer.

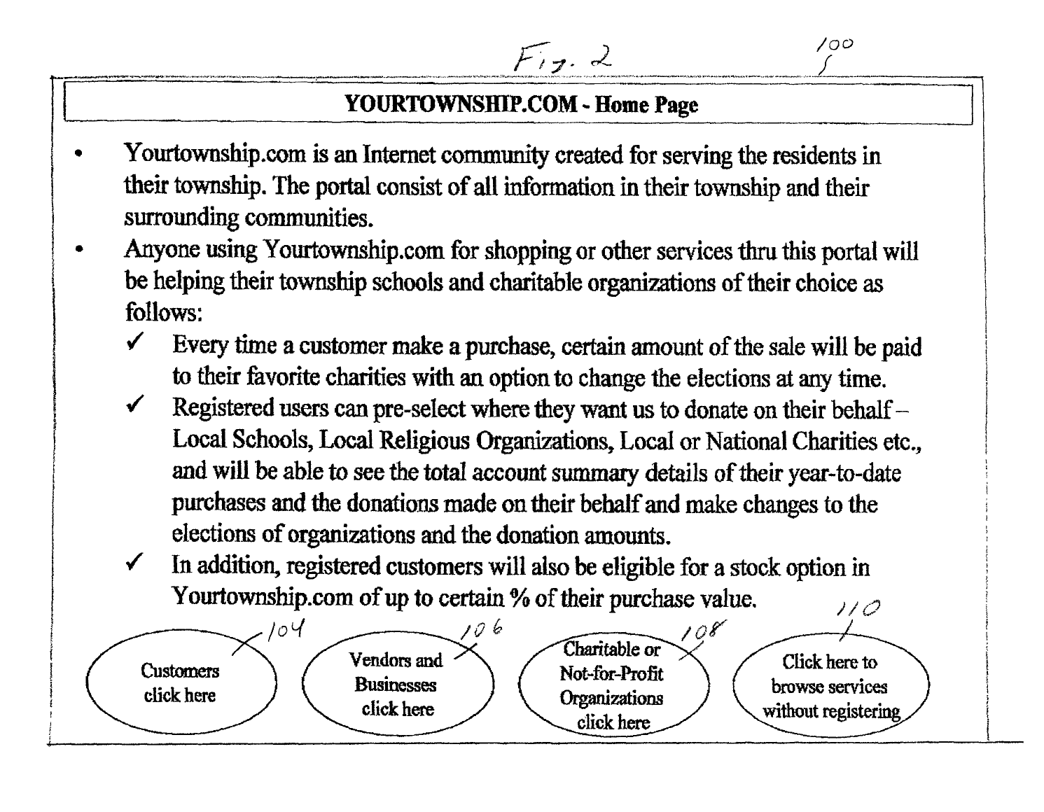

FIG. 2 shows a home page 100 which can be displayed on the user display 18 of FIG. 1. The home page 100 is displayed when an user enters the web site address for the home page 100. For example, if the web site address is “www.yourtownship.com”, the home page 100 will be displayed on the user display 18 by the user processor 12 after a user enters the web site address by using the user interactive device 16, and after the user processor 12 takes that address and requests from the server computer 22 through the Internet 20 the home page 100 for that web site and after the user processor 12 receives that home page 100. The home page 100 can be a starting point for a method in accordance with an embodiment of the present invention.

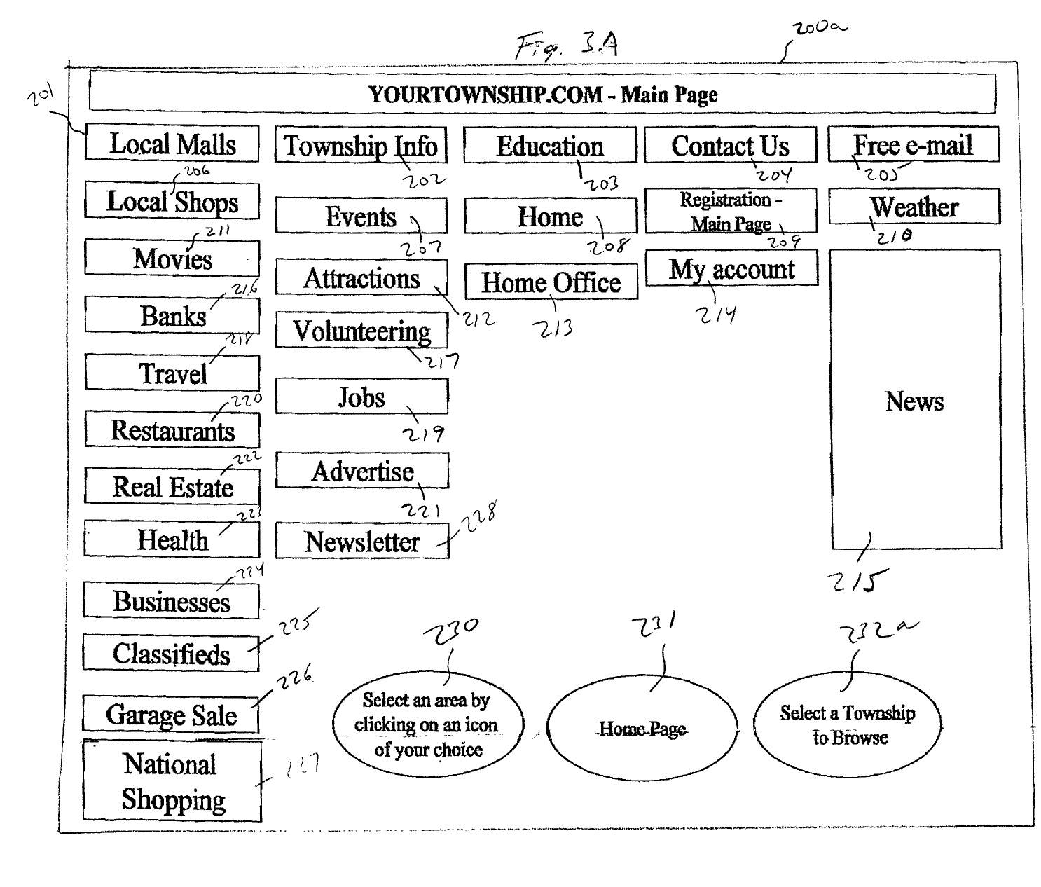

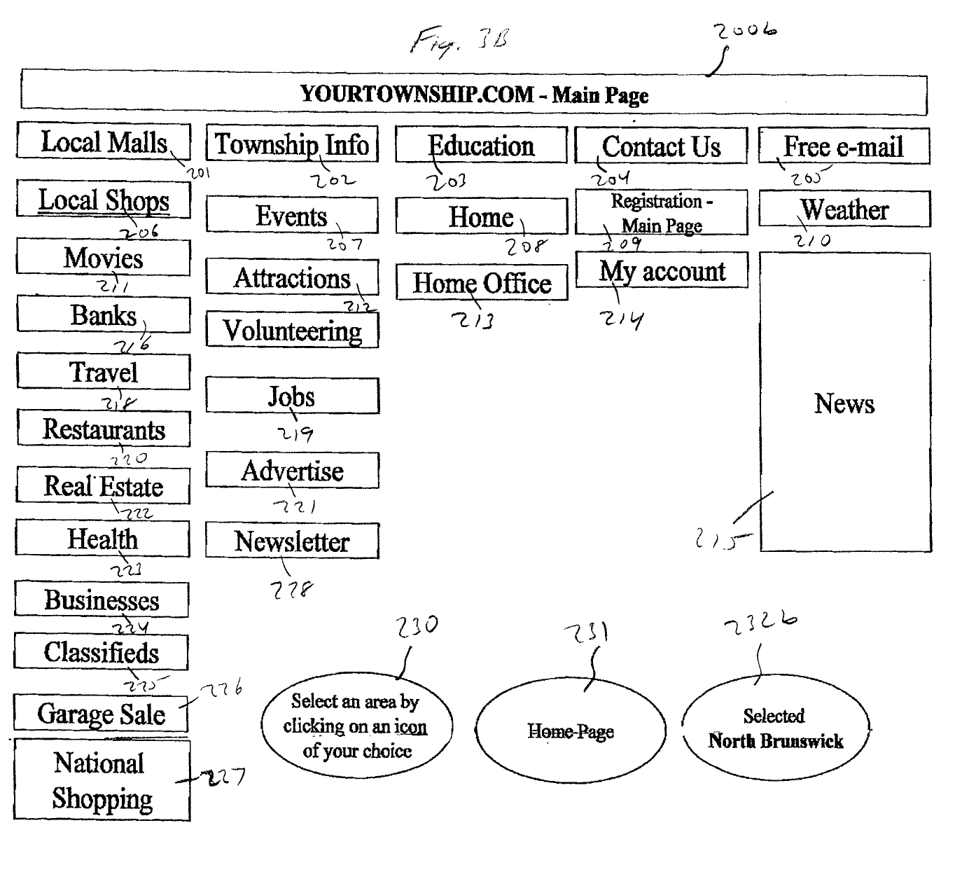

The home page 100 and the various web pages shown on FIG. 3A to FIG. 18 may be downloaded from the server computer 22, which is connected to the Internet 20 through telecommunications channel 20a, to the user processor 12 via telecommunications channel 12d and then to the user display 18 through bus 12c. The data for the home page 100 and various other web pages may be stored in the memory 14 via bus 12a. The web pages on FIGS. 2-18 may be supplied to the display 18 in any known manner. A user may use the user interactive device 16 of FIG. 1, which may be for example include a computer mouse, to click on a field or a link in the various web pages in FIG. 2 to FIG. 18.

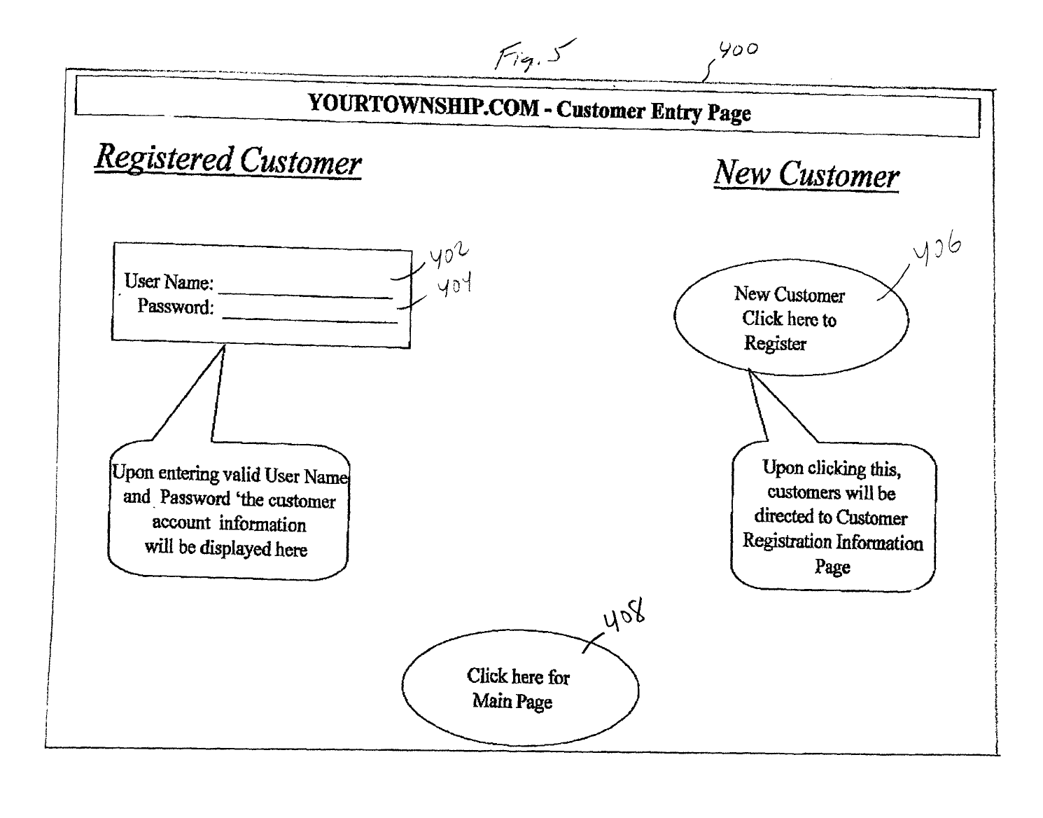

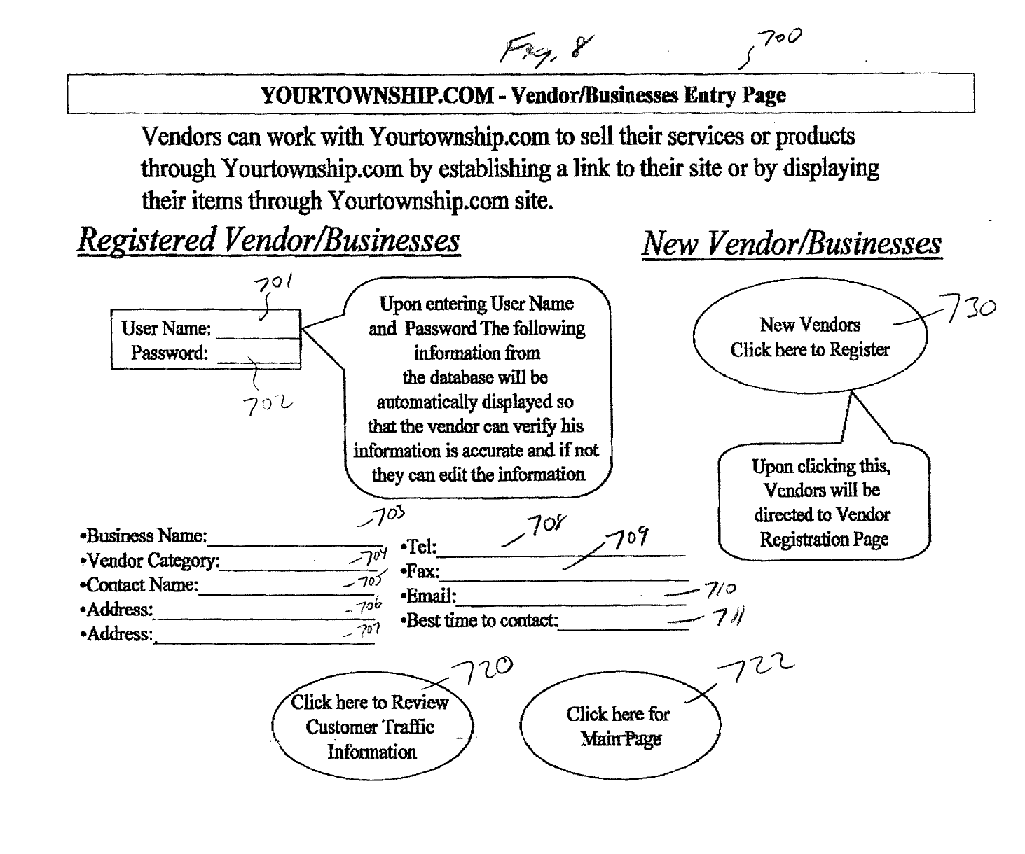

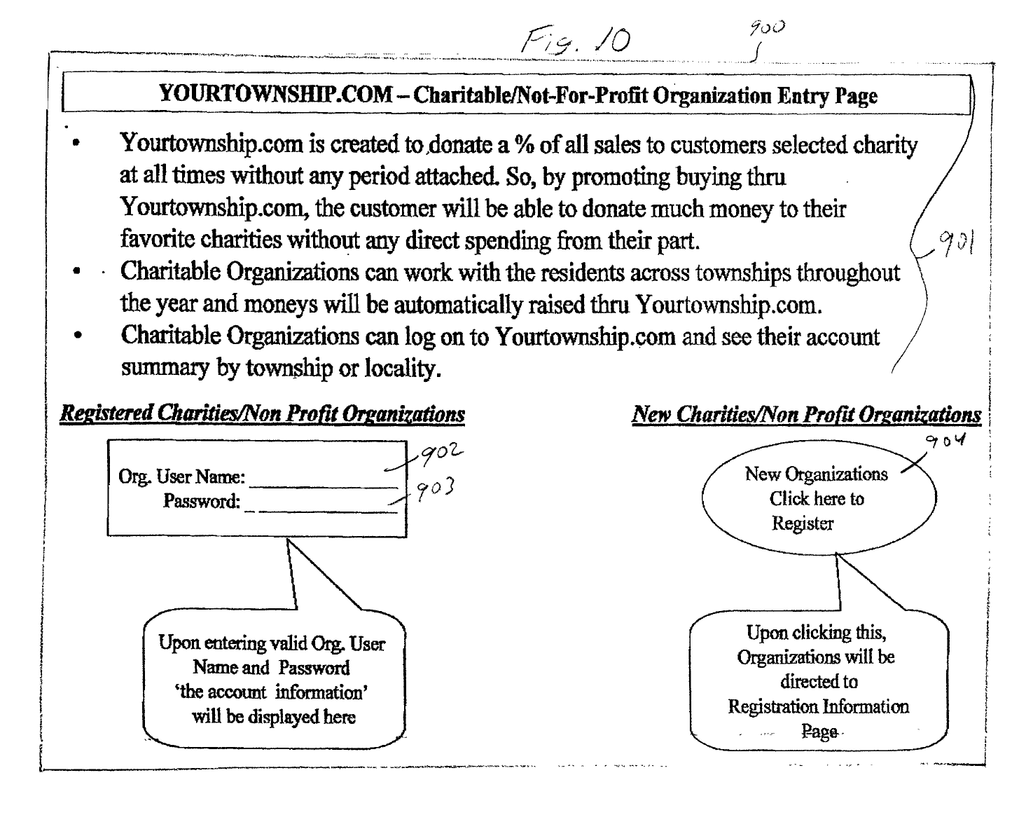

The home page 100 includes text 102. The home page 100 also includes fields or links 104, 106, 108, and 110. An operator can click on any of the links 104, 106, 108, or 110 (can also be called fields or icons), using a mouse which may be part of the user interactive device 16. When a user clicks on the link 104, the customer entry web page 400, shown in FIG. 5, is downloaded from the server computer 22 and placed on the display 18 by the user processor 12, replacing the previous web page on the display 18. Similarly, when a user clicks on the links 106, 108, and 110, the vendor/businesses entry web page 700 shown in FIG. 8, the charitable/not-for-profit organization entry page 900 shown in FIG. 10, and the first version of the main page 200a shown in FIG. 3A, respectively, are downloaded from the server computer 22 through the Internet 20 and placed on the user display 18 by the user processor 12, replacing the previous web page on the user display 18.

FIG. 3A shows a first version 200a of the main page which can be displayed on the user display 18 of FIG. 1 by clicking on the link 110 shown in FIG. 2. The main page first version 200a includes fields or links 201-228, and 230-232a. Each link of links 201-228 and 230-232a can be clicked by a computer mouse which may be part of interactive device 16, to allow a user to purchase goods or services or to display another web page of information not shown for a specific township or local region, or to go to another web page. For example, clicking on “Local Malls” link 201 may display, a web page which lists all the malls in a given township or within a certain radius of a township. Similarly, clicking on “Township Info” link 202, “Education” link 203, “Local Shops” link 206, “Events” link 207, “Weather” link 210, “Movies” link 211, “Attractions” link 212, “News” link 215, “Banks” link 216, “Volunteering” link 217, “Restaurants” link 220, “Businesses” link 224, “Garage Sale” link 226, and “Newsletter” link 228, may cause the displaying on display 18 of information about township or local activities, businesses, or happenings.

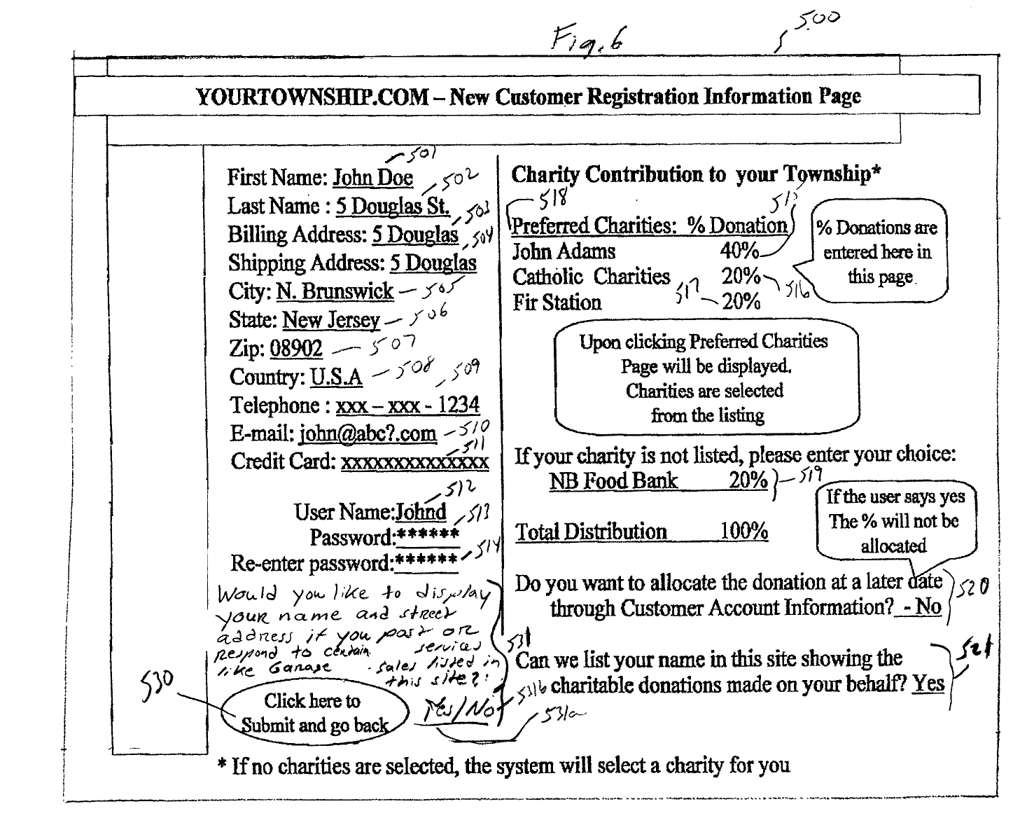

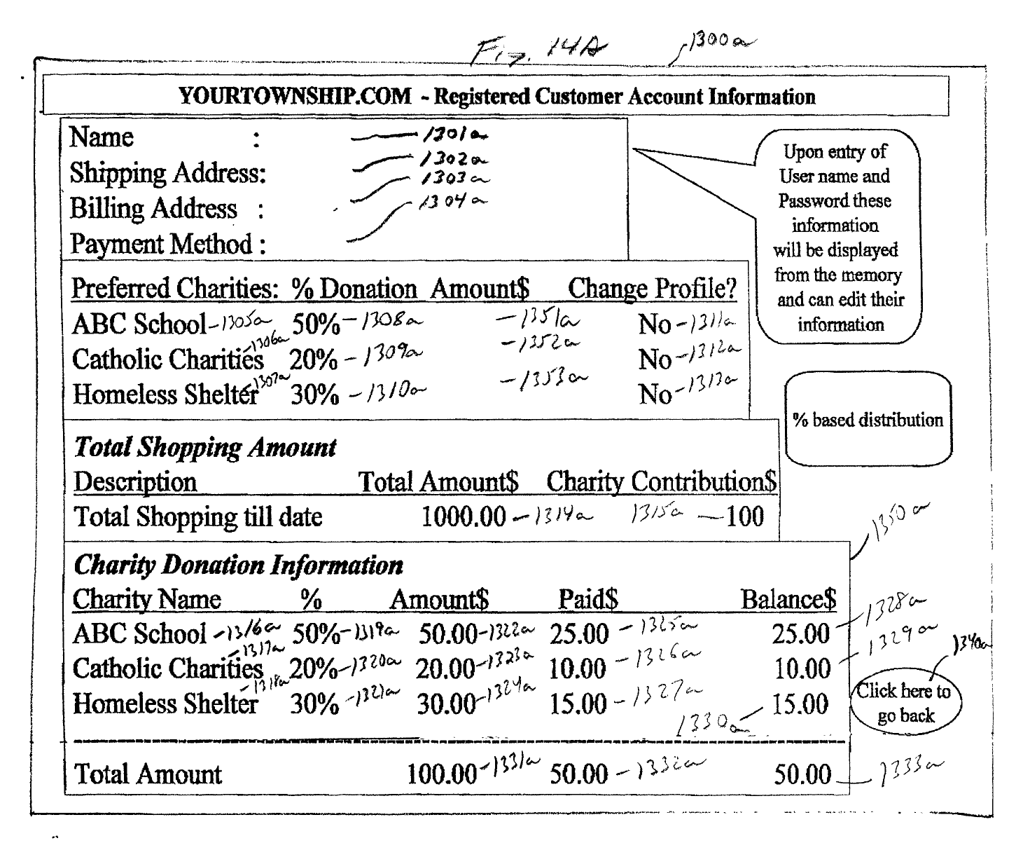

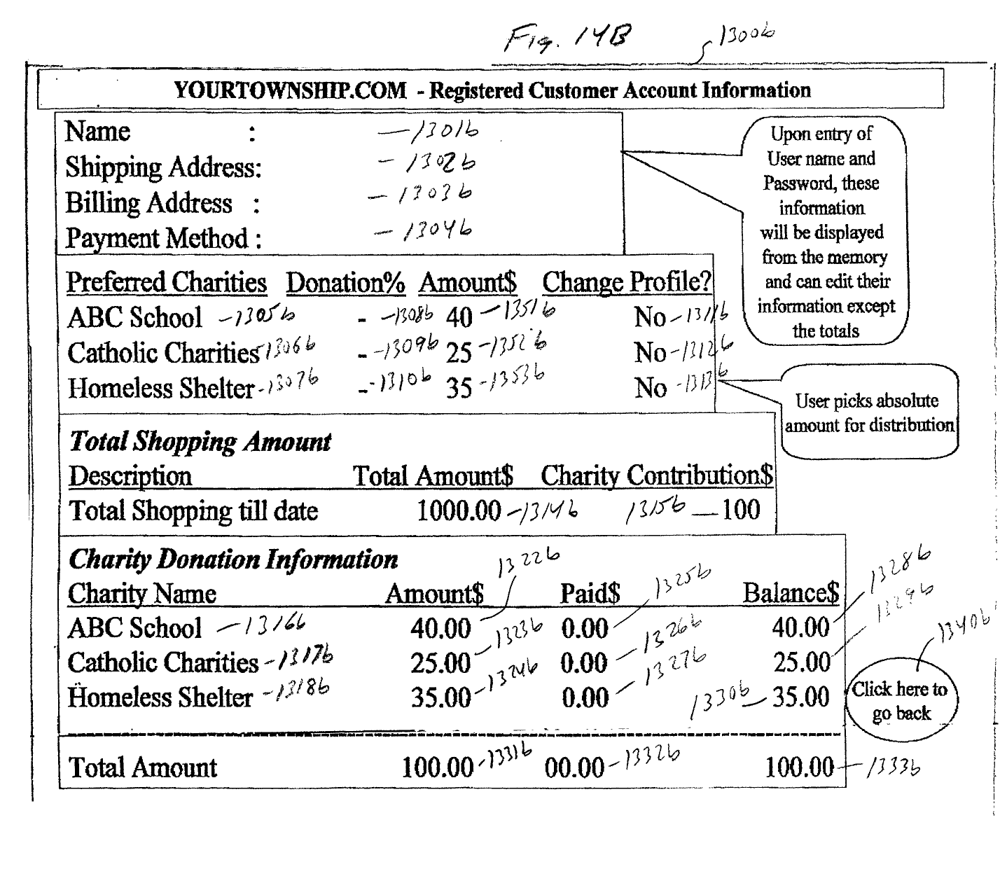

The “Contact Us” link 204 may allow an operator to contact the providers of the web site (in this case called “Yourtownship.com”) The “Free e-mail” link 205 may allow a user to sign up for new e-mail accounts and to retrieve his e-mail for free. Links 208 and 209 can be clicked on to allow an operator to go to the home page 100 show in FIG. 2 and to a new customer registration main page 500 in FIG. 6, respectively. The “home office” link 213 will cause a web page to display information regarding small and home offices, tips, new, organizations supporting small office development etc. Clicking on the “My account” link 214 causes the web page version 1300a in FIG. 14A or the web page version 1300b in 14B to be displayed. Clicking on “Travel” link 218 may cause a travel web page to appear, which is not shown. Clicking on the “Jobs” link 219 may cause the processor 12 to retrieve and display on display 18 a web page including a listing of jobs in the township or local area. The “Real Estate” link 222 can be clicked on to display a web page of local real estate for sale and other related information. The “Advertise” link 221 and the “Classifieds” link 225 may when clicked on cause the displaying of a listing of local advertisements or local classifieds, respectively. The “Advertise” link 221 and the “Classified” link 225 may also, when clicked on, provide information about advertising and about posting a classified, respectively, on “yourtownship.com” web site. The “Health” link 223 may when clicked on cause a general health information web page to be displayed. Clicking on the “National Shopping” link 227 may cause a web page to be displayed which includes a nationwide listing of retailers.

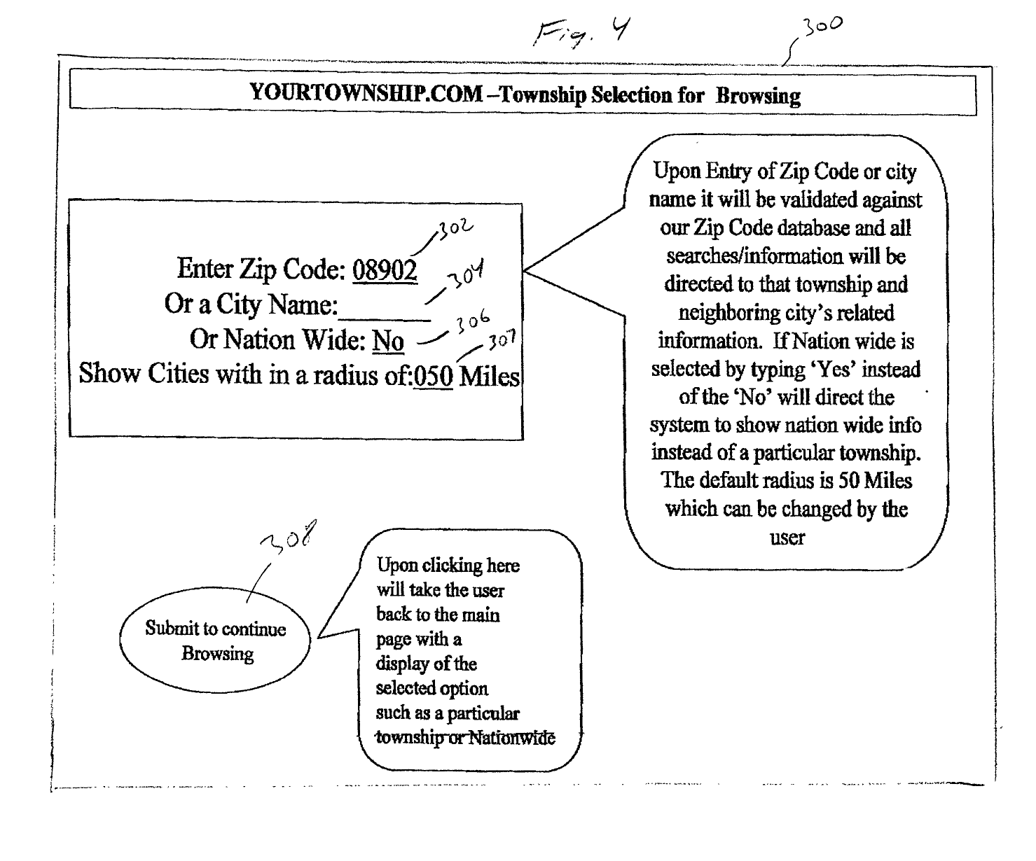

The “Home page” link 231 in FIG. 3A, when clicked on, will cause the user processor 12 to display the home page 100 of FIG. 2. When an operator clicks on the “Select a Township to Browse” link 232a, the user processor 12 displays the web page 300 on FIG. 4 on the user display 18. FIG. 3B shows a second version 200b of the main web page, after the township of “North Brunswick” has been selected. The only difference between the version 200a and 200b FIG. 3A and FIG. 3B is that in 200b the words “Selected North Brunswick” appear in the field 232b while in version 200a the words “Select a Township to Browse” appear.

When the user clicks on the link 232a in FIG. 3A, the web page 300 of FIG. 4 is displayed to select the appropriate township or to select a nationwide option. The web page 300 includes fields 302, 304, 306, 307, and 308. A user can type (using interactive device 16 which may include a keyboard) a zip code into field 302, or a city name in field 304 or an indication of “yes” in field 306 as to whether a search should be conducted “Nationwide”. The user can also provide an indication that information regarding cities (or townships) within a radius of a certain number of miles should be provided. The user should provide an entry into only one of the three fields 302, 304, or 306, and also can provide a different radius in field 307. The default radius is fifty miles and would apply if a zip code is entered in field 302 or a city name is entered in field 304 so that information will be provided within a radius of fifty miles of for example North Brunswick or for example zip code 08902. After entering, for example a city name (or township name) such as “North Brunswick in field 302, the user should click on link 308, which will cause the display of the main page as shown in FIG. 3B with the words “North Brunswick” showing in the field 232b on the user display 18. If the user input “Yes” in field 306 of web page 300 shown in FIG. 4, for “nationwide” then the field 232b would have shown “nationwide” instead of “North Brunswick”. Entering the zip code into field 302 causes the information on the web site shown by FIGS. 2-18 to be specific to that zip code or that local area within a certain radius of that zip code.

FIG. 5 shows a customer entry web page 400 which can be displayed on the user display 18 of FIG. 1. A user displays the web page 400 by clicking on the link 104 of home page 100 in FIG. 2. The customer entry web page 400 includes field 402 for entering the “User Name” and field 404 for entering the user's “Password”. Upon entry of a valid customer user name and password into fields 402 and 404 the registered customer account information web page first version 1300a of FIG. 14A or the second version 1300b of FIG. 14B will be retrieved from the server computer 22 and displayed on user display 18 by processor 12. The customer entry web page 400 also includes link 406 for registration of a new customer. Clicking on the link 406 will cause the processor 12 to retrieve from the server computer 22 through the Internet 20 and display on user display 18 the “New Customer Registration Information” web page 500 shown in FIG. 6. The web page 400 also includes link 408 which when clicked on causes either the first version 200a of FIG. 3A or the second version 200b of FIG. 3B to be displayed on the user display 18 (there may be a different township or “nationwide” entered in field 232b depending on what is selected).

The new customer registration information web page 500 shown in FIG. 6, includes fields 501-517 and 519-521 for entering information about a new customer. Web page 500 also includes link 530 for causing new customer information to be submitted to the server computer 22 through the internet 20 by the user processor 12.

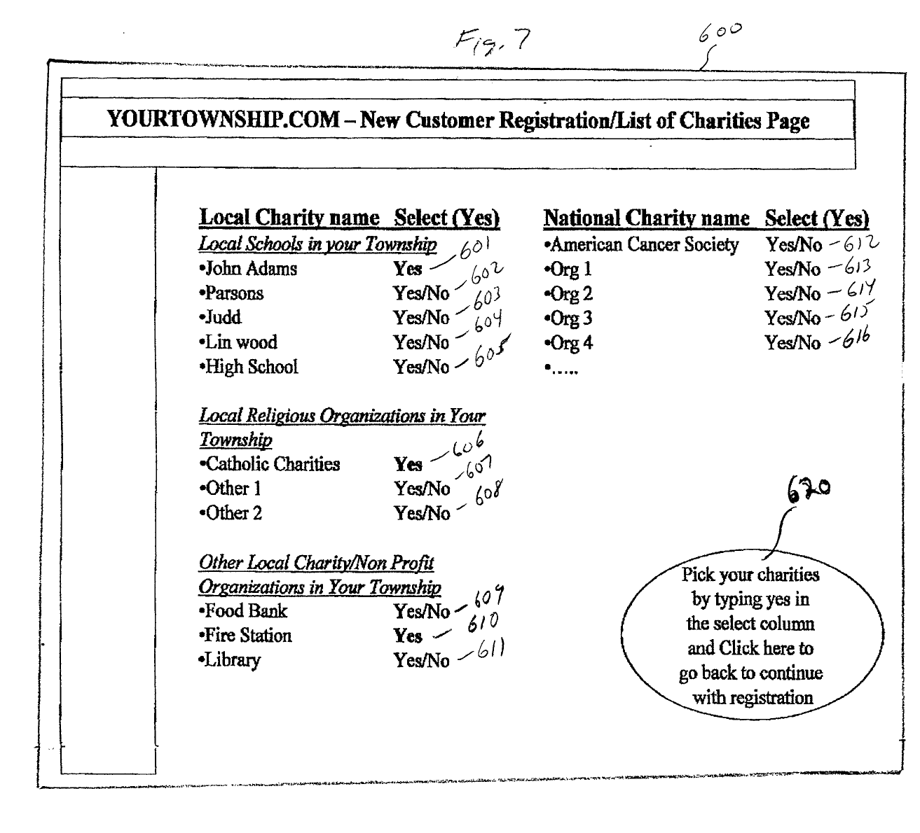

Fields 501-514 and 520 have information shown in FIG. 6 which is self explanatory (such as “First Name” etc.). Fields 515, 516, and 517 show percentages for donating part of a purchase price of goods or services purchased through this web site (in this case “yourtownship.com”). Alternatively instead of designating percentages in fields 515-517, dollar amounts could be designated. The “Preferred Charities” link 518 may be clicked on to cause the processor 12 to display the web page 600 in FIG. 7. Field 519 may be used to enter a charity of the user's choice and to specify a percentage (or dollar amount) for donations to that charity. Field 520 can be used to allow the user to allocate donations at a later date. Field 521 can be used to allow a user to have his or her donation's listed on the web site “yourtownship.com”. Field or link 530 can be clicked on (using interactive device 16) to submit the new customer registration information data to the user processor 12 and the user processor 12 can then submit it to the server computer 22 through the internet 20, which will update the customer profile or customer data stored in the server computer 22.

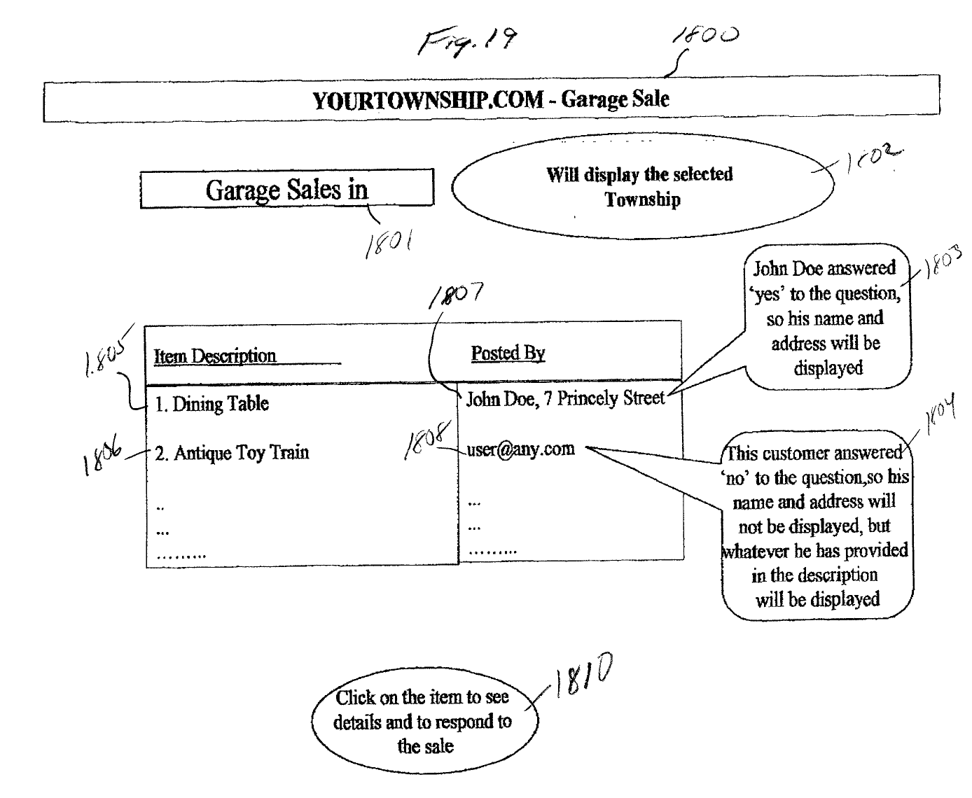

Web page 500 also includes link 531, which shows the text “would you like to display your name and street address if you post or respond to certain services like Garage sales listed in this site ?” and links 531a for “Yes” and 531b for “No”. If a customer clicks on link 531a for “Yes” and for example the customer has a posting on the garage sale section, the customer's listing will show his name and address instead of the customer's e-mail. This allows customer's or other users to pick up an item from an individual's street which may be easy if the item is available in the local community and saves on shipping, time and money for both parties. FIG. 19 shows a web page 1800 which provides garage sale information. Web page 1800 includes fields 1801, 1802, 1803, and 1804 providing various text information. Fields 1805 and 1806 show descriptions of various items. Fields 1807 and 1808 show who posted the various items for sale. For example, The “Dining table” in field 1805 was posted by John Doe, who has an address at 7 Princely Street as shown by field 1807. The user may click on either fields 1805 or 1806 to see details about the item and to respond to the sale. Field 1810 is further text information. The garage sale web page 1800 in FIG. 19 can be enterred from main page 200a or 200b and link 226. If the customer answered “No” by clicking on link 531b in FIG. 6 only the e-mail address will be displayed in his Garage sale listing, such as the listing shown in fields 1806 and 1808. In this case it will not be easy for the customer to identify the location and also who posted the item until the customer contacts the advertiser via e-mail unless the advertiser chose to put that information in the description of the item. The address display will work on all appropriate situations; the garage sale is just an example.

FIG. 7 shows the new customer registration information—list of charities web page 600. The web page 600 includes fields 601-616. The word “Yes” or “No” can be typed into each field (through interactive device 16) of fields 601-616. A “Yes” answer means that money will be donated to a particular charity. A “No” answer means that money will not be donated to a particular charity. In this manner a customer can select the list of charities which he wants a portion, percentage, or a dollar amount of a purchase price for goods or services to go to. After the charities are selected in web page 600, a user or customer can click on link 620 to cause the selections to be processed by processor 12 and sent to the server computer 22 through the Internet 20.

FIG. 8 shows a vendor/business entry web page 700 which can be displayed on the user display 18 when a user clicks on the link 106 of home page 100 of FIG. 2. The web page 700 includes fields 701 and 702 into which a user can enter his or her name and password. Following the entry of a user's name and password the user processor 12 will automatically display the users business name, vendor category, contact name, address (first), address (second), telephone number, fax number, e-mail address, and best time to contact in fields 703, 704, 705, 706, 707, 708, 709, 710, and 711, respectively. This information may be retrieved by the processor 12 from the server computer 22 through the Internet 20 and displayed on user display 18.

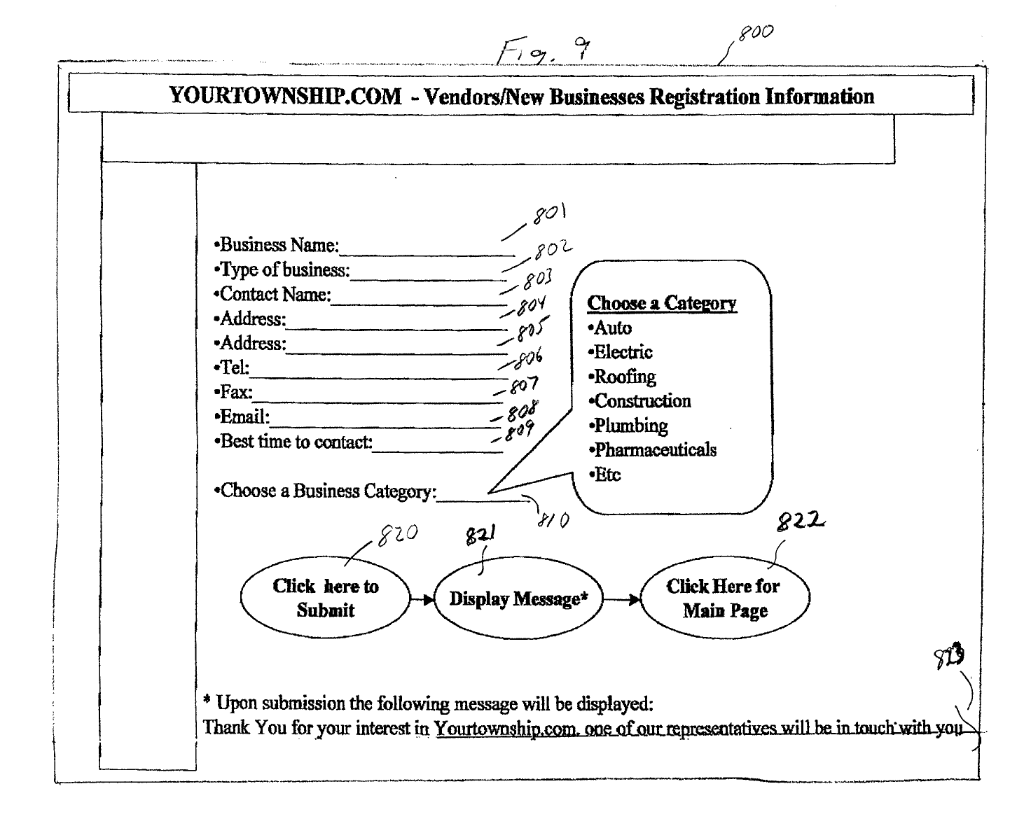

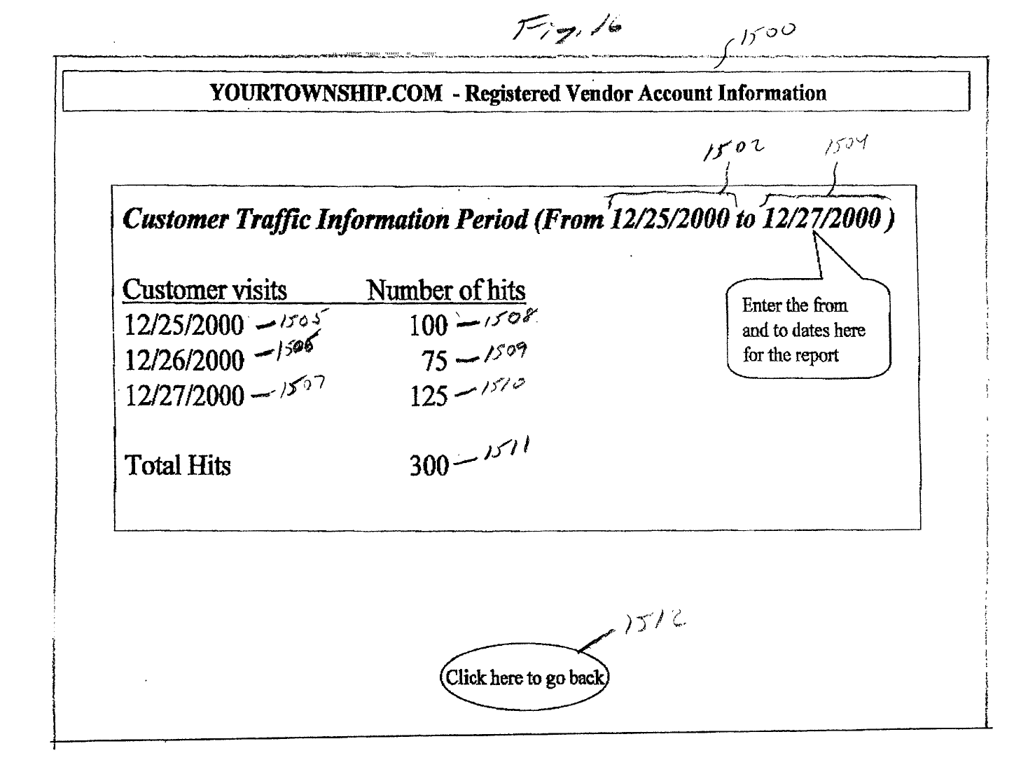

The web page 700 in FIG. 8 includes link 730, which when clicked on causes the user processor 12 to display vendors/new business registration information web page 800 shown in FIG. 9. The web page 700 also includes link 720 which when clicked on causes the display of web page 1500 of FIG. 16, which shows customer traffic, and link 722 which when clicked on causes display of the version 200a or 200b of main web page to be displayed.

The web page 800 in FIG. 9 includes fields 801, 802, 803, 804, 805, 806, 807, 808, 809, and 810 into which business name, type of business, contact name, address (first), address (second), telephone number, fax number, e-mail address, best time to contact and a business category, respectively can be entered. After a user has typed in the various information in fields 801-810, the user may submit that information to processor 12 and thus to the server computer 22 through the Internet 20 by clicking on field 820. A representative from “yourtownship.com” (for example) will contact the vendor to discuss how the vendor can establish a link to their site or enter into advertisement contracts etc. If agreeable with the terms and conditions, a user name and password will be assigned to them and provided to them by phone or via e-mail so that they can monitor customer traffic etc. to the vendor's site from “yourtownship.com”. Web page 800 also includes field 821, field 822 and a message 823. The message 823 will be displayed on the web page 800 after the link 820 is clicked on. Clicking on the link 822 causes the version 200a or 200b of the main page in FIG. 3A or 3B to be displayed. See the web page 1500 in FIG. 16 for the registered vendor account information.

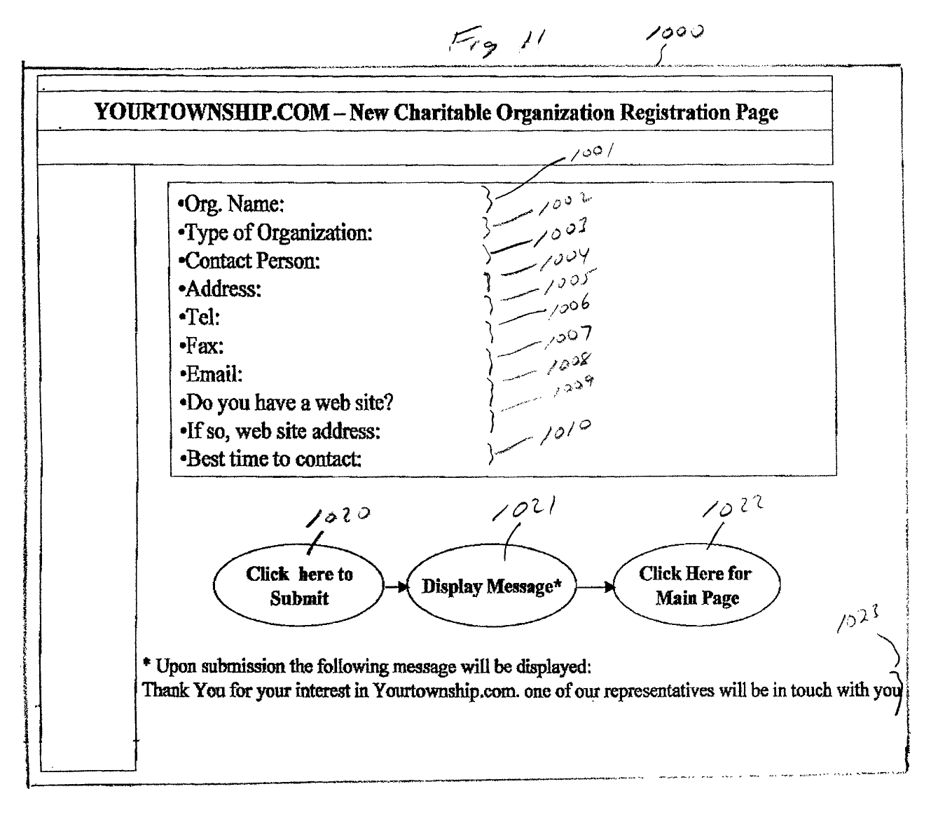

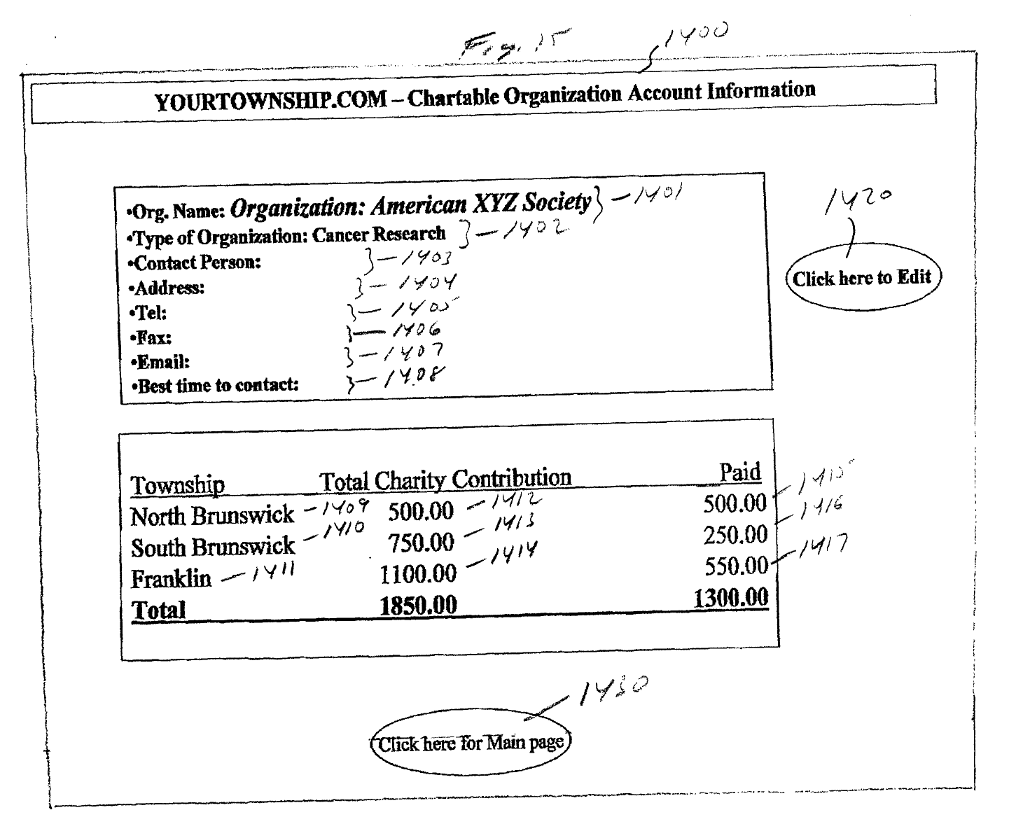

FIG. 10 shows a charitable/not-for-profit organization entry web page 900 which can be displayed on the user display 18 of FIG. 1. A user can click on the link 108 on the home page of FIG. 2 in order to display the web page 900. The web page 900 includes text 901 and fields 902 and 903 for entering organization user name and password, respectively. Upon a user entering a valid organization name and password in fields 902 and 903, the charitable organization account information web page 1400 shown in FIG. 15 is displayed on the user display 18 by the user processor 12. If this is a new charity or non profit organization, the organization or user can click on link 904 which will cause the user processor 12 to display on the user display 18 the new charitable organization registration web page 1000 shown in FIG. 11.

The new charitable organization registration web page 1000 includes fields 1001, 1002, 1003, 1004, 1005, 1006, 1007, 1008, 1009, and 1010 for entering an organization name, a type of organization, a contact person, an address, a telephone number, a fax machine number, an email address, an answer to whether the organization has a web site, the web site address if any, and best time to contact, respectively. The web page 1000 includes a link 1020 which can be clicked on by a user to submit the information entered in fields 1001-1010 to processor 12 and thereafter to server computer 22 through the internet 20. A representative may contact the charitable organization after the information entered in web page 1000 is processed. Web page 1000 also includes field 1021, field 1022, and message 1023. Clicking on the link 1020 causes the displaying of the message 1023 on the web page 1000. Clicking on the link 1022 causes either version 200a in FIG. 3A or version 200b in FIG. 3B of the main page to be displayed on user display 18.

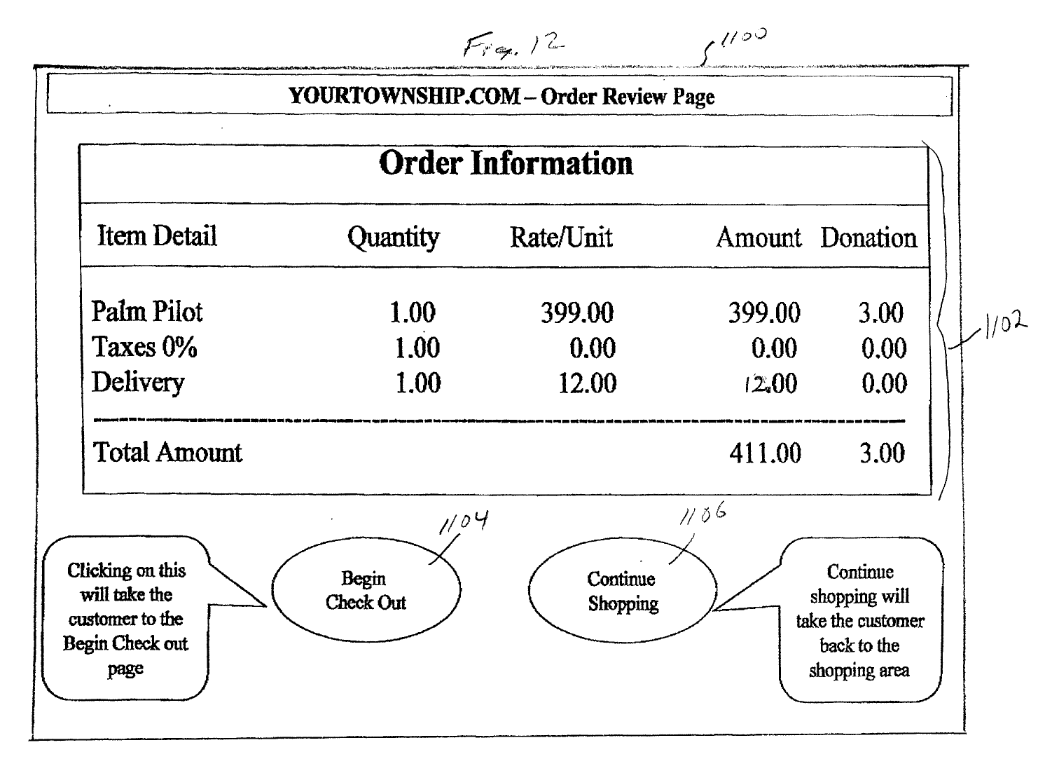

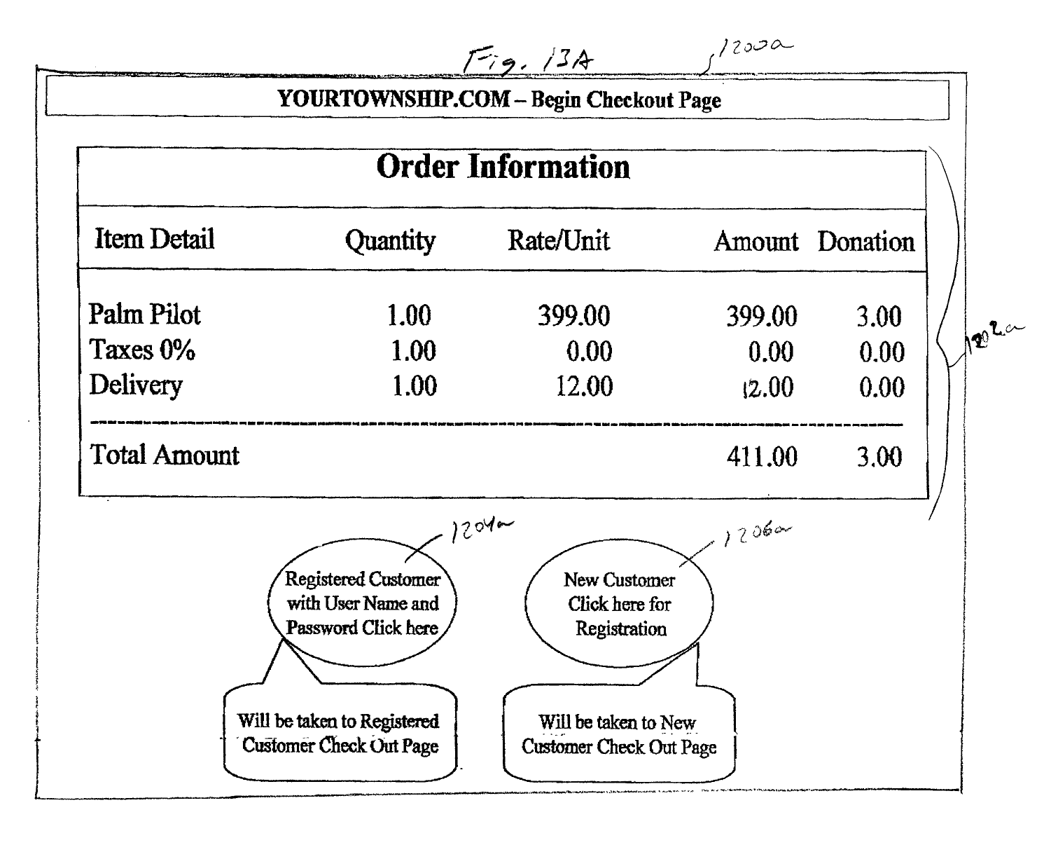

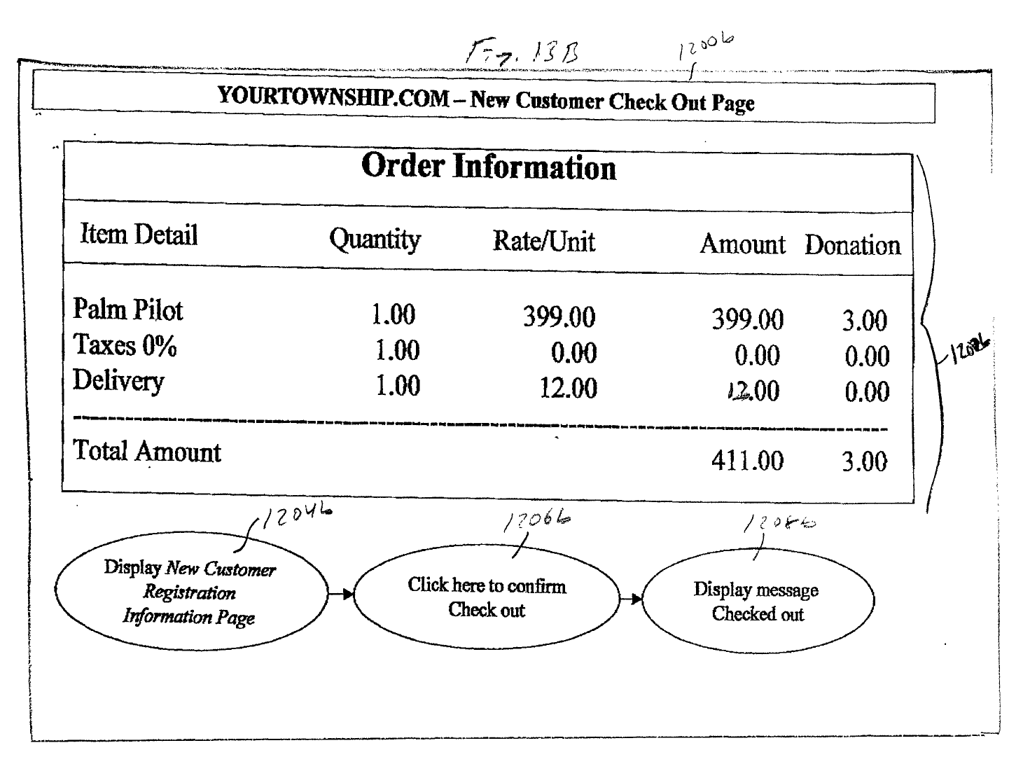

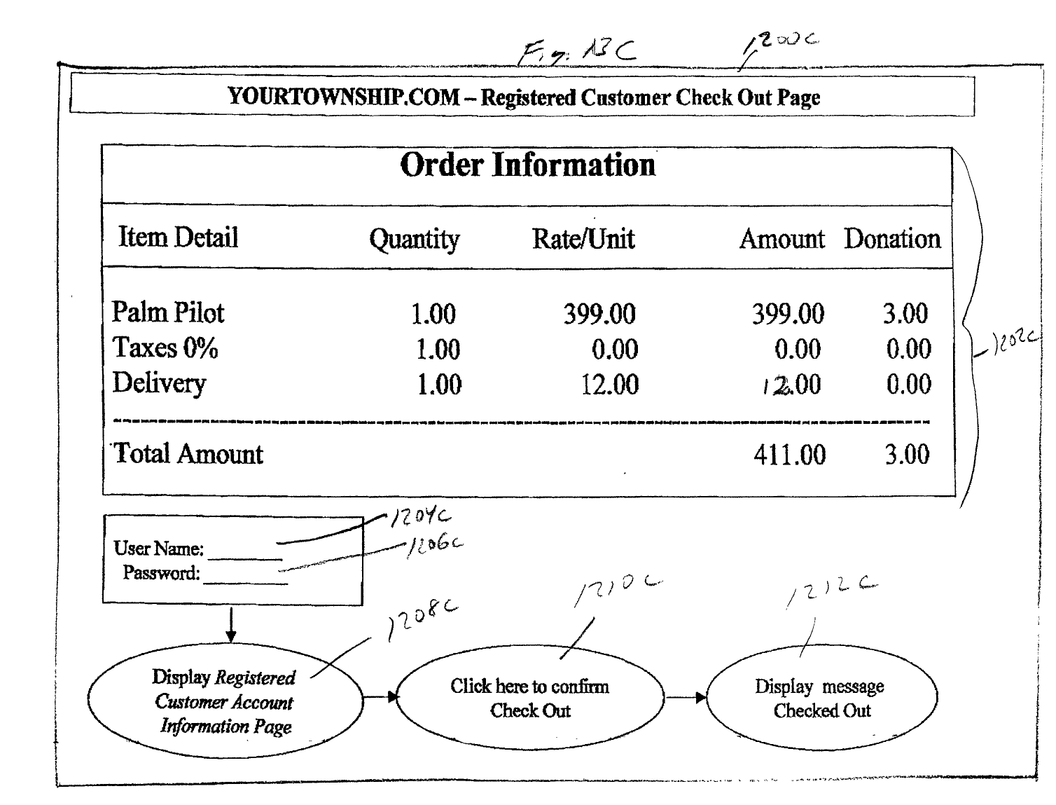

FIG. 12 shows an order review web page 1100 which can be displayed on the user display 18. The order review web page 1100 includes the text 1102. The text 1102 specifies order information regarding products or services ordered by the user through the web site “yourtownship.com”. In this case the user has ordered one “Palm Pilot”. The order information in FIG. 12 shows that in this case there is a delivery charge of “12.00” and no charge for taxes. The web page 1100 also includes a link 1104 which can be clicked on to cause the user processor 12 to display the begin checkout web page 1200a shown in FIG. 13A. The web page 1100 also includes link 1106 which can be clicked on to cause the user processor 12 to display the main page 200a or 200b of FIG. 3A and 3B, respectively, to allow the user to continue to shop for goods or services.

A typical customer order process would be as follows.

From the main page 200a in FIG. 3A, a customer clicks on the link 232a to select a township. This step is typically needed only if information for a specific township is required.

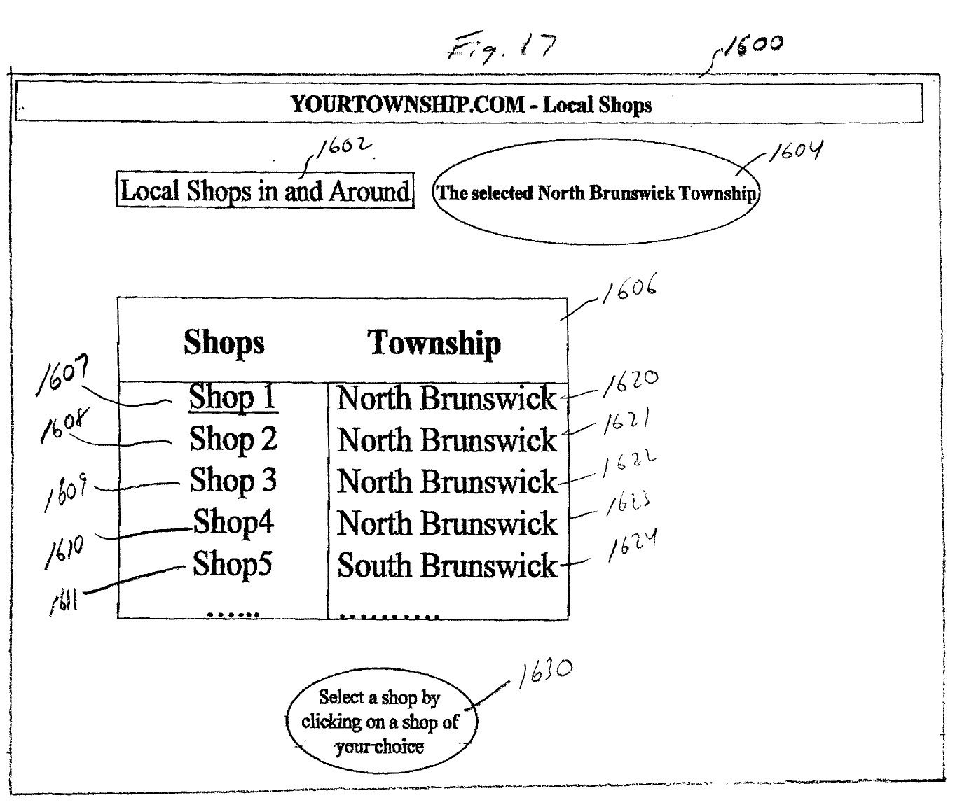

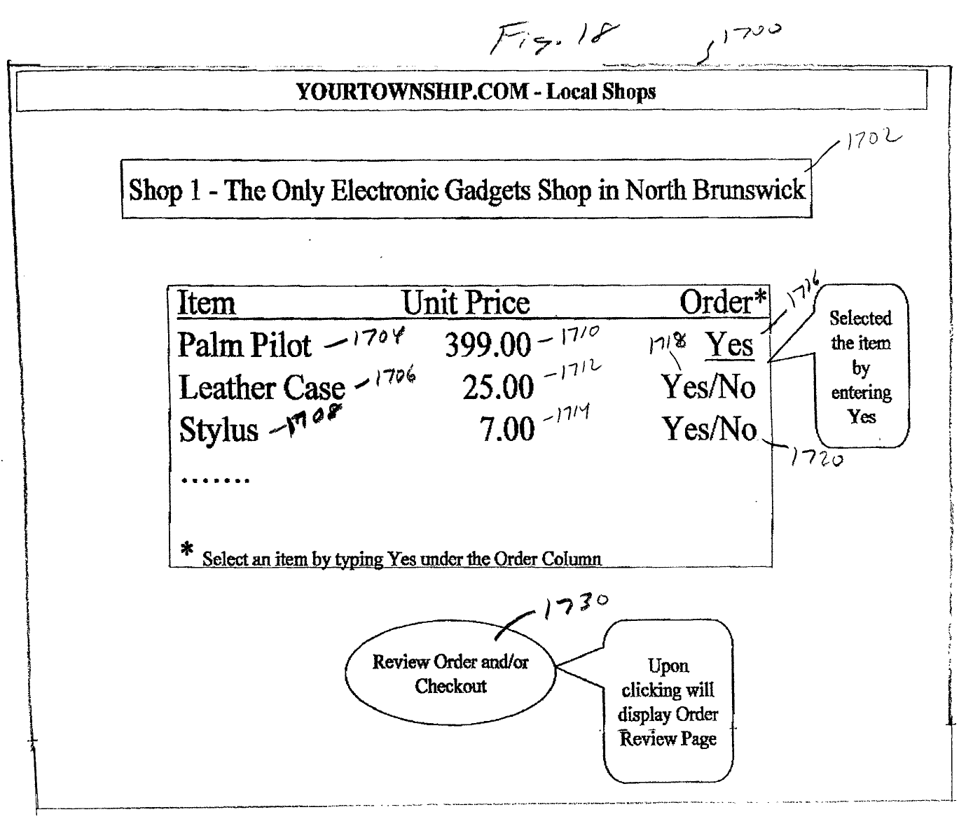

The user may select North Brunswick township, for example, by entering the words “North Brunswick” in field 304 next to “Or a City Name:” on web page 300 of FIG. 4. The user then clicks on link 308 to go back to main page 200b in FIG. 3B, with the words “North Brunswick” now appearing in field 232b. From main page 200b, the user may click on, for example, link 206 for “Local Shops”. Web page 1600 of FIG. 17 may then be displayed which lists the local shops “Shop1” through “Shop5” in fields 1607 through 1611. The user may click on link 1607 for local shop “Shop 1”. Web page 1700 of FIG. 18 may then be displayed which lists the items local shop 1 has for sale such as a “Palm Pilot”, a “Leather Case”, and a “Stylus” in fields 1704, 1706, and 1708 respectively. A user may select an item by entering “Yes” in one of the corresponding fields 1716, 1718, and 1720. For example, field 1716 corresponds to the “Palm Pilot”. The user may then click on the field or icon 1730, which causes the order review web page 1100 of FIG. 12 to be displayed. The customer may continue to shop by clicking on link 1106 which will cause the web page 1700 in FIG. 18 for shop1 again, or the customer may choose check out by clicking on the link 1104, which will cause the begin checkout web page 1200a of FIG. 13A to be displayed.

FIG. 13A shows the begin checkout web page 1200a. The begin checkout web page 1200a includes text 1202a which shows various order information. The web page 1200a includes link 1204a which when clicked on will cause the registered customer check out web page 1200c in FIG. 13C to be displayed on user display 18. Web page 1200a also includes link 1206a which when clicked on will cause the new customer account check out web page 1200b to displayed on the user display 18.

FIG. 13B shows the new customer account check out web page 1200b. The web page 1200b includes text 1202b which shows various order information and links 1204b, 1206b, and 1208b. Link 1204b when clicked on displays the new customer registration information web page 500 in FIG. 6. Clicking on link 1206b may confirm the check out and a message may be displayed saying “you are checked out” as shown in field 1208b.

FIG. 13C shows a registered customer checkout web page 1200c includes text 1202c which shows various order information. The web page 1200c includes fields 1204c and 1206c into which can be entered the user name and password, respectively. Web page 1200c includes fields 1208c, 1210c, and 1212c. Clicking on field 1208c causes the customer account information web page version 1300a of FIG. 14A or version 1300b of FIG. 14B to be displayed on the user display 18. Links 1210c is similar to links 1206b which when clicked on will display a message such as shown in 1208b.

FIG. 14A shows a registered customer account information web page version 1300a which can be displayed on the user display 18 of FIG. 1. The web page 1300a includes fields 1301a-1333a and 1351a-1353a, which allow the entry by a user of various information. A user may enter name, shipping address, billing address, and payment method into fields 1301a, 1302a, 1303a, and 1304a, respectively. A user may enter as many charities as desired under “Preferred Charities”, although currently only fields 1305a, 1306a, and 1307a for three charities are shown. Money may be donated to the various charities on the percentage basis defined by the user, for example, 50% to ABC school as entered in field 1308a, 20% to Catholic Charities as entered in field 1309a, and 30% to Homeless Shelter as entered in field 1310a. Money may also be donated on a dollar amount basis in the fields 1351a-1353a. If the percentage has been changed (also called a “change in profile”) the user can put “Yes” in any of fields 1311 a, 1312a, or 1313a for the particular charity. Fields 1314a and 1315a are set by the server computer 22 and are typically not altered by the user. Fields 1314a and 1315a show how much the user has spent through the web site (“Yourtownship.com”) and how much of that total amount has been donated to charity, respectively. The table 1350a shows various charity donation information including the names of various charities in fields 1316a-1318a, the percentages donated to each charity in fields 1319a1321a, the amounts donated to each charity in fields 1322a-1324a, the amounts paid to each charity in fields 1325a-1327a and the balance remaining to be paid to each charity in fields 1328a-1330a. Total amounts for various categories are shown in Fields 1331 a, 1332a and 1333a. Field 1340a is a link which can be clicked on to go back to the main web page 200a, shown in FIG. 3A or web page 200b in FIG. 3B, whichever is appropriate.

FIG. 14B shows registered customer account information version 1300b. The difference between version 1300a and 1300b is that version 1300b shows dollar amounts in fields 1351b-1353b and no percentages in fields 1308b-1310b. Otherwise fields 1301b-1318b and 1322b-1333b contain in web page 1300b contain largely the same information as the fields 1301a-1333a in web page 1300a. Field 1340b can also be clicked on to go to main web page 200a or 200b whichever is appropriate.

FIG. 15 shows a charitable organization account information web page 1400 which can be displayed on the user display 18 of FIG. 1. The web page 1400 includes fields 1401, 1402, 1403, 1404, 1405, 1406, 1407, and 1408 into which may be entered by a user Organization name, type of organization, contact person, address, telephone number, fax number, e-mail address, and best time to contact, respectively. The web page 1400 also includes fields 1409, 1410, and 1411, each of which specify a township, fields 1412, 1413, and 1414 each of which specifies a total amount contributed by the customers of that particular township to the charity as shown in field 1401, and fields 1415-1417 which specify an amount already paid by that particular township. The web page 1400 includes field 1420 can be clicked on to edit the fields 1401-1408 on web page 1400. The web page 1400 also includes field 1430 which can be clicked on to go to cause the processor 12 to display the main web page 200a or 200b whichever is appropriate.

FIG. 16 shows a registered vendor account information web page 1500 which includes field 1502 for entering a start date and field 1504 for entering an end date. After a vendor enters the start date and end date, customer traffic information is displayed in fields 1505-11. The web page 1500 also includes fields 1505-1507 which display customer visit dates to a particular vendor through “yourtownship.com”. Fields 1508-1510 show corresponding number of hits for the particular vendor for the particular date. Field 1512 allows a user to go back to the main page, i.e. either web page 200a or web page 200b.

FIG. 17 shows a local shops web page 1600 which includes fields 1602, 1604, 1607-1611, 1620-1624, and 1630. Field 1602 is a text field. Field 1604 identifies the township or area already selected. Fields 1607-1611 show the names of five shops in the North Brunswick Township area, which is this case are “Shop1”, “Shop2” etc. Fields 1620-1624 identify the township location of each shop. Field 1630 tells a user to select a shop by clicking on a shop. A user may click on any one of fields 1607-1611. For example, clicking on field 1607 for “Shop1” causes Shop1's web page 1700 of FIG. 18 to appear on the user display 18.

Shop1's web page 1700 includes field 1702 which identifies the shop. Web page 1700 also includes fields 1704, 1706, and 1708 which identify items the shop sells, and fields 1710, 1712, and 1714 which specify a price for each item. Fields 1716, 1718, and 1720 allow a user to purchase an item in the corresponding row by entering “Yes” in the appropriate field. The web page 1700 includes field 1730 which can be clicked on to display the order review web page 1100 of FIG. 12.

In operation, a user enters a specific web site address into interactive device 16 to utilize an embodiment of the present invention. For example, the user may enter “yourtownship.com” and then click on “enter”. At that point the first web page or home page 100 shown in FIG. 2 of the “yourtownship.com” web site would be downloaded from the server computer 22 through the Internet 20, telecommunications channel 12d, user processor 12, and bus 12c and displayed on the user display 18. The home page 100 would also be stored in user memory 14.

A user may then click on link 104 (by using a computer mouse of interactive device 16) to go to (i.e. to display on display 18) customer entry web page 400 of FIG. 5, link 106 to go to vendor/businesses entry web page 700 of FIG. 8, link 108 to go to charitable/not-for-profit organization entry web page 900 of FIG. 10, or link 110 to go to the main web page 200a of FIG. 3A.

In the customer entry web page 400 of FIG. 5, a registered customer upon entering a valid user name and password in fields 402 and 404 will have his account information from web pages 1300a or 1300b in FIG. 14A or 14B displayed on display 18. The user can edit the account information on web pages 1300a or 1300b. Clicking on link 1340a or 1340b of web pages 1300a or 1300b will cause the main web page 200a or 200b of FIG. 3A or 3B to be displayed. The web page 200a or 200b allows the user to “shop” for various products and services or to obtain various information.

Users which are new customers may click on link 406 of the customer entry web page 400 of FIG. 5 to display web page 500 of FIG. 6 which allows registration. A new customer may then enter the various information in fields 501-517, and 519-520. A new customer may specify various “Preferred Charities” (which can also be called donees) to donate to by clicking on the “Preferred Charities” field 518 which causes web page 600 of FIG. 7 to be displayed on display 18. The user may then type “Yes” or “No” in any of the fields 601-616 to either select or not select a charity for donations. The user may then click on link 620 to go back to web page 500 of FIG. 6. The charities selected on web page 600 will be automatically displayed on web page 500 under field 518 “Preferred Charities”. The user may enter the percentages to donate to each charity on the web page 500 of FIG. 6. The user may submit to the server computer 22 through the internet 20 the names and percentages for the various charities and the information shown on web page 500 by clicking on the link 530 of web page 500. The user processor 12 or the server computer 22 may verify that the percentages for the charity donations add up to a total of 100%. If not then an appropriate error message may be sent from the server computer 22 through the internet 20 to the user processor 12 and be displayed on the user display 18. If percentages are not entered, then the server computer 22 may assign a percent distribution on an equal basis to the listed charities. If no charities are selected, a local preferred charity may be assigned by the server computer 22.

If the vendor/businesses entry web page 700 of FIG. 8 is selected, a user who is already registered may type in their user name and password in fields 701 and 702, which upon verification will cause data to be automatically be displayed in fields 703-711 on the user display 18. The data may come from server computer 22 and be supplied to processor 12 which then causes it to be displayed on display 18. A user can edit the information in fields 703-711. A user can save the changes to the server computer 22 by clicking on the link 722. Clicking on the link 722 also causes the main page 200a or 200b of FIG. 3A or 3B to be displayed on the user display 18, which allows the user to shop for goods, services, and/or to retrieve information. Each good or service which can be purchased by a user can be called an “item”.

New vendors or businesses may click on the link 730 in web page 700 which causes web page 800 shown in FIG. 9 to be displayed on the user display 18. The new vendor or business may then enter information into fields 801-810 and click on link 820 to submit that information to the server computer 22.

Charitable/not-for-profit organizations may click on link 108 to display web page 900 of FIG. 10. Registered organizations can enter their user name and password in fields 902 and 903, respectively, which upon verification by the server computer 22 causes their account information shown on web page 1400 of FIG. 15 to be displayed on display 18. The user for the organization can edit the information for fields 1401-1408 on web page 1400 by clicking on link 1420. The information in fields 1409-1417 is account data which can be determined by the server computer 22 and typically is not edited by a user of an organization. The user for the organization can click on link 1430 to save any changes to web page 1400 and to go to the main page 200a or 200b of FIG. 3A or 3B to shop for goods or services or to retrieve information.

Non-registered charitable or not-for-profit organizations may click on link 904 of web page 900 of FIG. 10 which will cause the web page 1000 of FIG. 11 to be displayed on display 18. A user for the organization may then enter information for fields 1001-1010 onto web page 1000. The information may be submitted to the server computer 22 by clicking on the link 1020. Clicking on the link 1020 also causes message 1023 to be displayed and clicking on link 1020 will cause the main page 200a or 200b of FIG. 3A or 3B to be displayed on the user display 18.

Clicking on the link 110 of the home page 100 causes the main web page 200a (or 200b of FIG. 3B if location of township already identified) of FIG. 3A to be displayed. As previously mentioned various goods and services and information can be ordered or selected from the main web page 200a or 200b. Many of the links 201a-230a (or 201b-230b or web page 200b) on web page 200a may be links to other web sites. For example a user may click on link 220a “Restaurants” to go to a web site which provides a listing of restaurants within a township or within a radius of a township.

The present invention in at least one embodiment may be thought of as creating an Internet community. It can be used as a portal for serving the residents communities across the country. The portal may include information about a particular community or township and about the surrounding communities or townships, information about large and small businesses in the community, job listings, shopping and sale information, listings and activities of charitable organizations, government offices and their services and the like. Anyone using the web site of at least one embodiment of the present invention for shopping or other related services may help their township, their schools and/or charitable organizations of their choice. Communities have their own schools, businesses, shops, libraries, and other organizations where the residents will be sharing as part of their daily life. Residents spend money every day as part of their life. They spend money on their neighborhood stores, Internet stores, stores away from home, etc.

A portion of the money a user spends through a web site in accordance with the present invention may be directed to their own community for charities, schools and to help poor people. Alternatively or additionally a portion of the money a user spends through the web site may be provided back to the user as stock for ownership in the company that owns the web site.

A certain percent of the purchase value of goods or services purchased through a web site in accordance with the present invention may be donated to community programs and/or charities of the customer's choice. The donation amount may be determined based on product value, its profitability, etc., and may be available to the customer at the time of the transaction. A web site in accordance with the present invention may use the following procedure to donate to charities:

At the time of customer registration the customer may fill out a form as on web page 500 FIG. 6. The form will be community specific where the schools and community organizations of the township will be listed. There will be a provision to change the elections after the registration process also. The contributions may be disbursed as per their elections periodically. The customer may have the option to see their total contributions as they elected and based on their purchase value. The list of the people who have contributed to these charities will be published in our web site periodically provided they have authorized us to do so. All customers using a web site in accordance with the present invention may be entitled to stock options for a certain percentage of their annual purchase amount that may be determined as follows. Stock options may be issued at least once every year based on the average market value or the value of the stock to be determined by the management. If the amount accumulated is less than the value of a stock, the amount may be transferred to the following year. If a customer is not interested in owning stocks, the customers may be able to convert their options to cash value on a percentage basis (To be determined).

For all goods and services sold, a web site in accordance with one or more embodiments of the present invention (which may be called for example “yourtownship.com”) may allocate a certain percentage of the purchase value to donate to charitable or public causes. The allocated moneys may be donated to the organizations selected by the people who use, for example “Yourtownship.com”.

The allocated donation amount may be a fixed amount per item sold or may be a percentage of the sales value of the goods or service. In accordance with at least one embodiment, the purchaser will be able to see the donation amount during the purchase or during checkout. A web site in accordance with embodiments of the present invention, such as “Yourtownship.com” may provide a list of charities in the locality of the customer, such as the charities shown under “Local Charity Name” in FIG. 7 in addition to providing a list of national charities, such as the charities shown under “National Charity Name” in FIG. 7. Individuals using “Yourtownship.com” may also have the option of entering their own organizations if they are not listed.

At the time of registering (for example at checkout, at the beginning of the purchase, or during browsing of the web site) the customers may select the charities and the amount to be allocated from their purchases. These selections will be stored in a customer's profile which may be stored in server computer 22 of FIG. 1 along with the customer's address and other information. For example, a Palm Pilot sold through “Yourtownship.com” may have a sales price of $300.00. The charity allocation for this item may be $3.00. If the customer selected two charities, for example at 50% each then “Yourtownship.com” may donate $1.50 each to these two organizations. The customer also may select the percent allocation of 50% during the charity or donor selection or can choose to allocate an absolute amount at a later date.

Instead of or in addition to regular listings of various information, drop down boxes may be used for the various web pages, check boxes may used intead of “yes” or “no” as would be recognized by those skilled in the art. Percent of charitable contributions and percent of stock options may be variable so that it can be changed from time to time or it may be fixed.

If any user or customer wants to contact any of the businesses or vendors listed on a web site in accordance with an embodiment of the present invention, such as “yourtownship.com”, instead of sending electronic mail (“e-mail”) directly to vendors/businesses, they can send e-mail to “yourtownship.com” and “yourtownship.com” will forward the e-mail to the appropriate vendor/business. As an example if a customer wants to contact Shop 1 (of FIG. 18) in North Brunswick they can send us an e-mail by clicking “contact us” in FIG. 3A and we will forward the email and information to Shop 1 or to an e-mail address for shop 1.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
providing a Internet web site which allows a purchaser to make a first purchase for a first amount of money of a first item through the web site;
wherein the Internet web site allows the purchaser to select a first donee to give a first portion of the first amount of money to;
and wherein the Internet web site causes the first portion of the first amount of money to be paid to the first donee.

2. The method of claim 1 further wherein
the Internet web site provides a list of potential donees and the purchaser selects the first donee from the list of potential donees.

3. The method of claim 2 further wherein
the Internet web site receives the purchaser's address and each potential donee on the list of potential donees has an address which is located in the same township as the address of the purchaser.

4. The method of claim 1 wherein
wherein the Internet web site allows the purchaser to select a second donee to give a second portion of the first amount of money to;
and wherein the Internet web site causes the second portion of the first amount of money to be paid to the second donee.

5. The method of claim 4 further wherein
the Internet web site provides a list of potential donees and the purchaser selects the first donee and the second donee from the list of potential donees.

6. The method of claim 5 further wherein
the Internet web site receives the purchaser's address and each potential donee on the list of potential donees has an address which is located in the same township as the address of the purchaser.

7. The method of claim 4 wherein
the first and second portions can be selected by the purchaser.

8. The method of claim 7 wherein
the first and second portions are percentages which can be selected by the purchaser.

9. The method of claim 7 further comprising
displaying the first and second portions on a computer display.

10. The method of claim 8 further comprising
displaying the first and second portions on a computer display.

11. The method of claim 1 wherein
the first donee is a charity.

12. The method of claim 2 wherein
the first donee and the potential donees are charities.

13. The method of claim 4 wherein
the first donee is a charity; and
the second donee is a charity

14. The method of claim 5 wherein
the first donee is a charity;
the second donee is a charity;
and the potential donees are charities.

15. A method comprising the steps of:
providing a Internet web site which allows a purchaser to make a first purchase for a first amount of money of a first item through the web site;
and wherein the Internet web site causes a portion of the first amount of money to be paid back to the purchaser in stock.

16. The method of claim 15 wherein
the stock is stock in the company which owns the Internet web site.

17. A method comprising the steps of:
providing an internet web site which allows a seller to post an item for sale; and
wherein the internet web site includes a web page which gives the seller the option to display his e-mail address or his street address for allowing a potential buyer to see the address where the item is offered for sale and to allow the buyer to decide whether to obtain the item for sale.

18. The method of claim 17 wherein
the internet web site allows sellers in a geographic region to post items for sale.

19. The method of claim 17 wherein
the internet web site allows sellers in a geographic region to post items for exchange;
and the internet web site allows sellers in a geographic region to offer items for free.

20. The method of claim 18 wherein
the geographic region is a township.

21. The method of claim 19 wherein
the user can choose from a list of business names to obtain customer service by e-mail.

22. The method of claim 19 wherein
the internet web site allows the user to send a message to the internet web site, and wherein the internet web site forwards the message on the user's behalf to the actual business.
